(19) United States
(12) Patent Application Publication
(10) Pub. No.: US 2015/0215158 A1
(43) Pub. Date: Jul. 30, 2015

(54) DISCRIMINATING OR PRIORITIZING USERS DURING FAILOVER IN A VOIP SYSTEM

(71) Applicant: QUALCOMM Incorporated, San Diego, CA (US)

(72) Inventors: Vijay Anandrao SURYAVANSHI, San Diego, CA (US); Mohammed Ataur Rahman SHUMAN, San Diego, CA (US); Mark MAGGENTI, Del Mar, CA (US)

(73) Assignee: QUALCOMM Incorporated, San Diego, CA (US)

(21) Appl. No.: 14/166,748

(22) Filed: Jan. 28, 2014

(51) Int. Cl. H04L 12/24; H04M 7/00

(52) U.S. Cl. CPC H04L 41/0668; H04M 7/0084

(57) ABSTRACT

An aspect of the disclosure is related to prioritizing users during a server failure. A client device or a central non-regional component detects that a server arbitrating a packet-based voice communication service in a first region has failed, and redirects the client device registered to utilize the packet-based voice communication service in the first region to a second server providing the packet-based voice communication service, wherein the redirecting is based on a priority level of a user of the client device. An aspect of the disclosure is related to peer-assisted failover recovery. A first client device detects that a server arbitrating a packet-based voice communication service in a first region has failed, and notifies a second client device in the first region that the server arbitrating the packet-based voice communication service in the first region has failed.

### BACKGROUND OF THE INVENTION

1. Field of the Invention

The disclosure is related to discriminating or prioritizing users during a failover in a voice over Internet protocol (VoIP) system.

2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long-Term Evolution (LTE) or WiMax). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

### SUMMARY

An aspect of the disclosure is related to prioritizing users during a server failure. A method for prioritizing users during a server failure includes detecting that a server arbitrating a packet-based voice communication service in a first region has failed, and redirecting a client device registered to utilize the packet-based voice communication service in the first region to a second server providing the packet-based voice communication service, wherein the redirecting is based on a priority level of a user of the client device.

An apparatus for prioritizing users during a server failure includes logic configured to detect that a server arbitrating a packet-based voice communication service in a first region has failed, and logic configured to redirect a client device registered to utilize the packet-based voice communication service in the first region to a second server providing the packet-based voice communication service, wherein the redirecting is based on a priority level of a user of the client device.

An aspect of the disclosure is related to peer-assisted failover recovery. A method for peer-assisted failover recovery includes detecting, by a first client device, that a server arbitrating a packet-based voice communication service in a first region has failed, and notifying, by the first client device, a second client device in the first region that the server arbitrating the packet-based voice communication service in the first region has failed.

An apparatus for peer-assisted failover recovery includes logic configured to detect, by a first client device, that a server arbitrating a packet-based voice communication service in a first region has failed, and logic configured to notify, by the first client device, a second client device in the first region that the server arbitrating the packet-based voice communication service in the first region has failed.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2 illustrates examples of user equipments (UEs) in accordance with embodiments of the invention.

FIG. 3 illustrates a communication device that includes logic configured to perform functionality in accordance with an embodiment of the invention.

FIG. 4 illustrates a server in accordance with an embodiment of the invention.

FIG. 5 illustrates an exemplary voice over Internet protocol (VoIP) deployment.

FIG. 6 is a call flow illustrating an exemplary failover to a secondary region/server.

FIG. 7 illustrates an exemplary flow for prioritizing users during a server failure.

FIG. 8 illustrates an exemplary flow for peer-assisted failover recovery.

FIG. 9 illustrates an example apparatus for prioritizing users during a server failure, represented as a series of interrelated functional modules.

FIG. 10 illustrates an example client device apparatus for peer-assisted failover recovery, represented as a series of interrelated functional modules.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, also referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

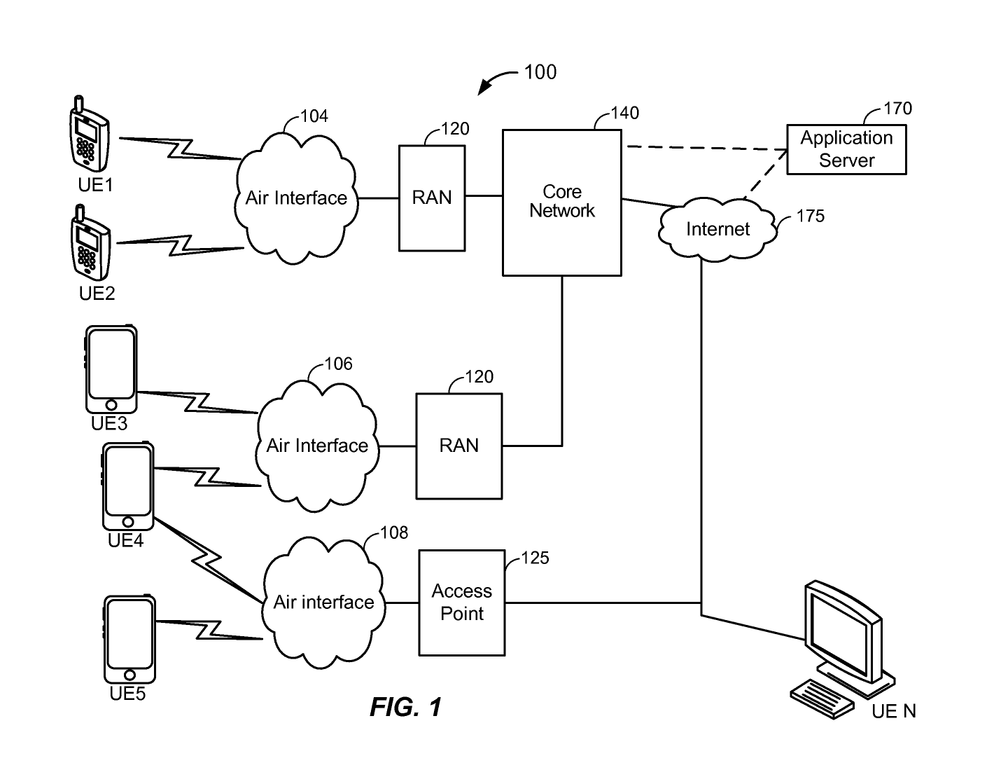

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a server 170 is shown as connected to the Internet 175, the core network 140, or both. The server 170 can be implemented as a plurality of structurally separate servers, or alternately may correspond to a single server. As will be described below in more detail, the server 170 is configured to support one or more communication services (e.g., Voice-over-Internet Protocol (VoIP) sessions, Push-to-Talk (PTT) sessions, group communication sessions, social networking services, etc.) for UEs that can connect to the server 170 via the core network 140 and/or the Internet 175, and/or to provide content (e.g., web page downloads) to the UEs.

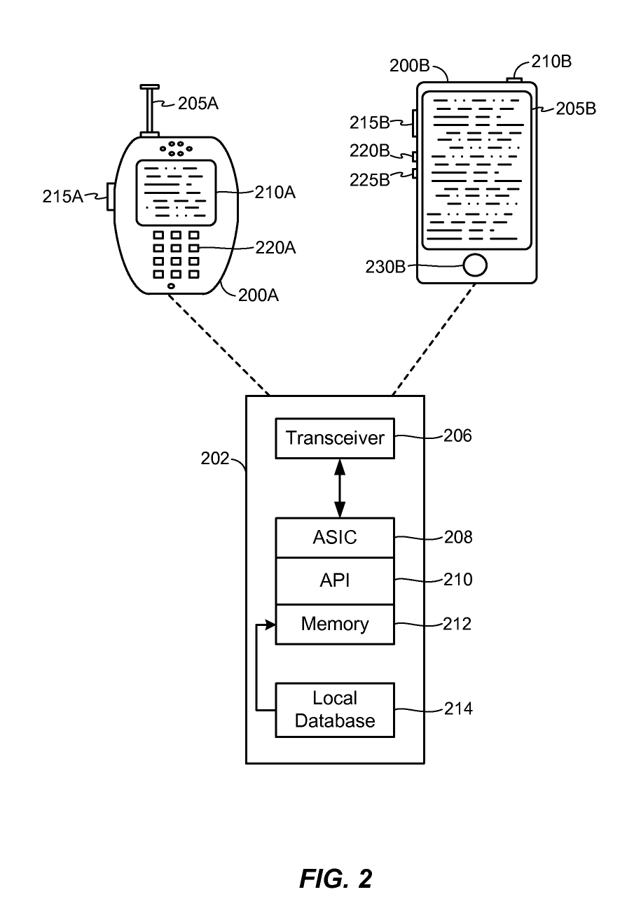

FIG. 2 illustrates examples of UEs (i.e., client devices) in accordance with embodiments of the invention. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), at least one front-panel button 230B (e.g., a Home button, etc.), among other components, as is known in the art. While not shown explicitly as part of UE 200B, the UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as the UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., application server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the invention is not limited to the illustrated features or arrangement.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

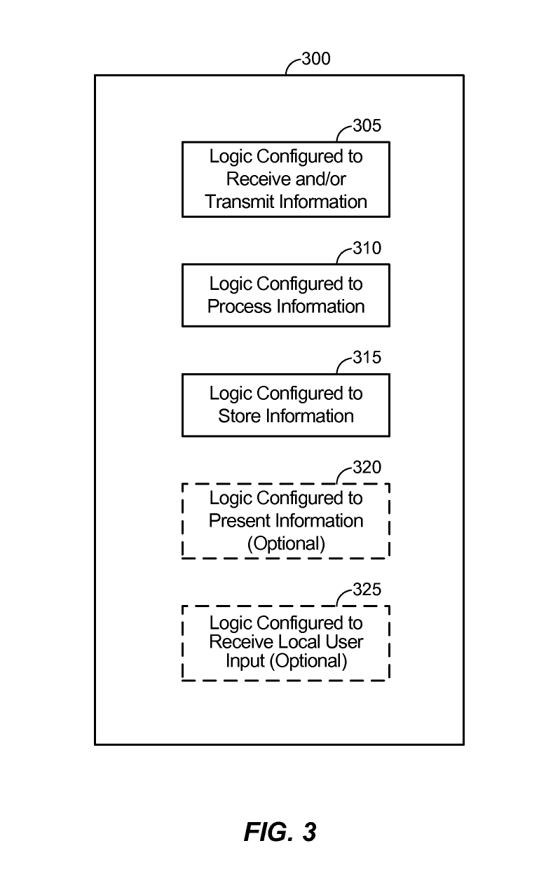

FIG. 3 illustrates a communication device 300 that includes logic configured to perform functionality. The communication device 300 can correspond to any of the above-noted communication devices, including but not limited to UEs 200A or 200B, any component of the RAN 120, any component of the core network 140, any components coupled with the core network 140 and/or the Internet 175 (e.g., the server 170), and so on. Thus, communication device 300 can correspond to any electronic device that is configured to communicate with (or facilitate communication with) one or more other entities over the wireless communications system 100 of FIG. 1.

Referring to FIG. 3, the communication device 300 includes logic configured to receive and/or transmit information 305. In an example, if the communication device 300 corresponds to a wireless communications device (e.g., UE 200A or 200B, AP 125, a BS, Node B or eNodeB in the RAN 120, etc.), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., server 170, etc.), the logic configured to receive and/or transmit information 305 can correspond to an Ethernet card, in an example, that connects the network-based server to other communication entities via an Ethernet protocol. As an example, the logic configured to receive and/or transmit information 305 may include logic configured to detect that a server arbitrating a packet-based voice communication service in a first region has failed, and logic configured to redirect a client device registered to utilize the packet-based voice communication service in the first region to a second server providing the packet-based voice communication service, wherein the redirecting is based on a priority level of a user of the client device. As another example, the logic configured to receive and/or transmit information 305 may include logic configured to detect, by a first client device, that a server arbitrating a packet-based voice communication service in a first region has failed, and logic configured to notify, by the first client device, a second client device in the first region that the server arbitrating the packet-based voice communication service in the first region has failed. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM memory, flash memory, ROM memory, EPROM memory, EEPROM memory, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communication devices, such as network communication devices that do not have a local user (e.g., network switches or routers, remote servers such as the server 170, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communication devices, such as network communication devices that do not have a local user (e.g., network switches or routers, remote servers such as the server 170, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

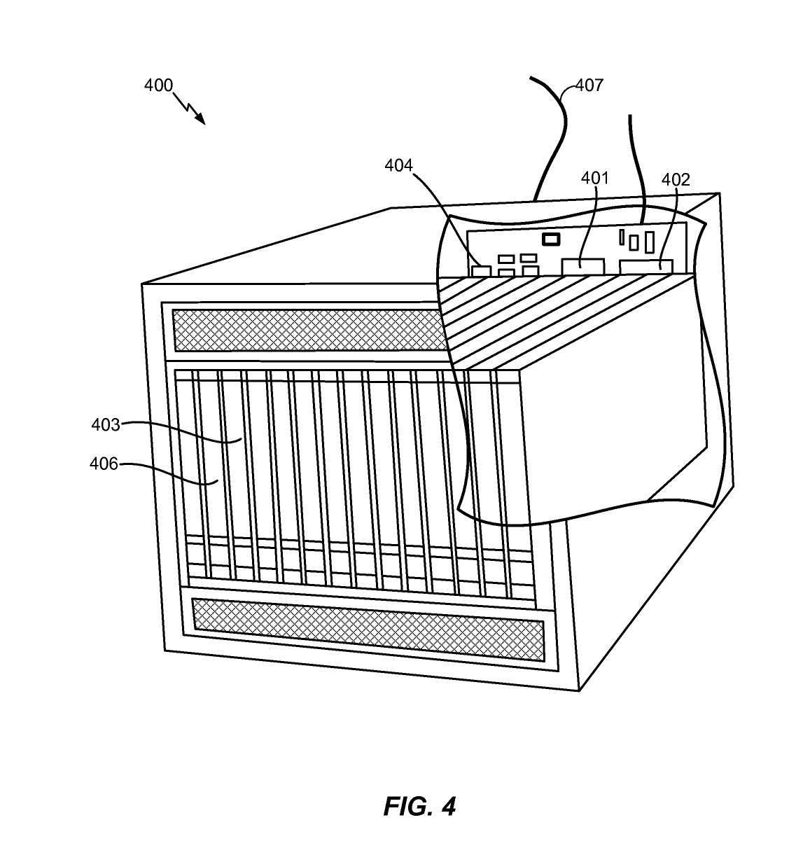

The various embodiments may be implemented on any of a variety of commercially available server devices, such as server 400 illustrated in FIG. 4. In an example, the server 400 may correspond to one example configuration of the application server 170 described above. In FIG. 4, the server 400 includes a processor 400 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access ports 304 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to a UE implementation as in 205A or 205B as in FIG. 2.

VoIP is a methodology for delivering voice communications and multimedia sessions over an IP network, such as the Internet. The steps involved in originating a VoIP call are similar to traditional digital telephony and involve signaling, channel setup, digitization of the analog voice signals, and encoding. Instead of being transmitted over a circuit-switched network, however, the call information is packetized and transmitted as IP packets over a packet-switched network.

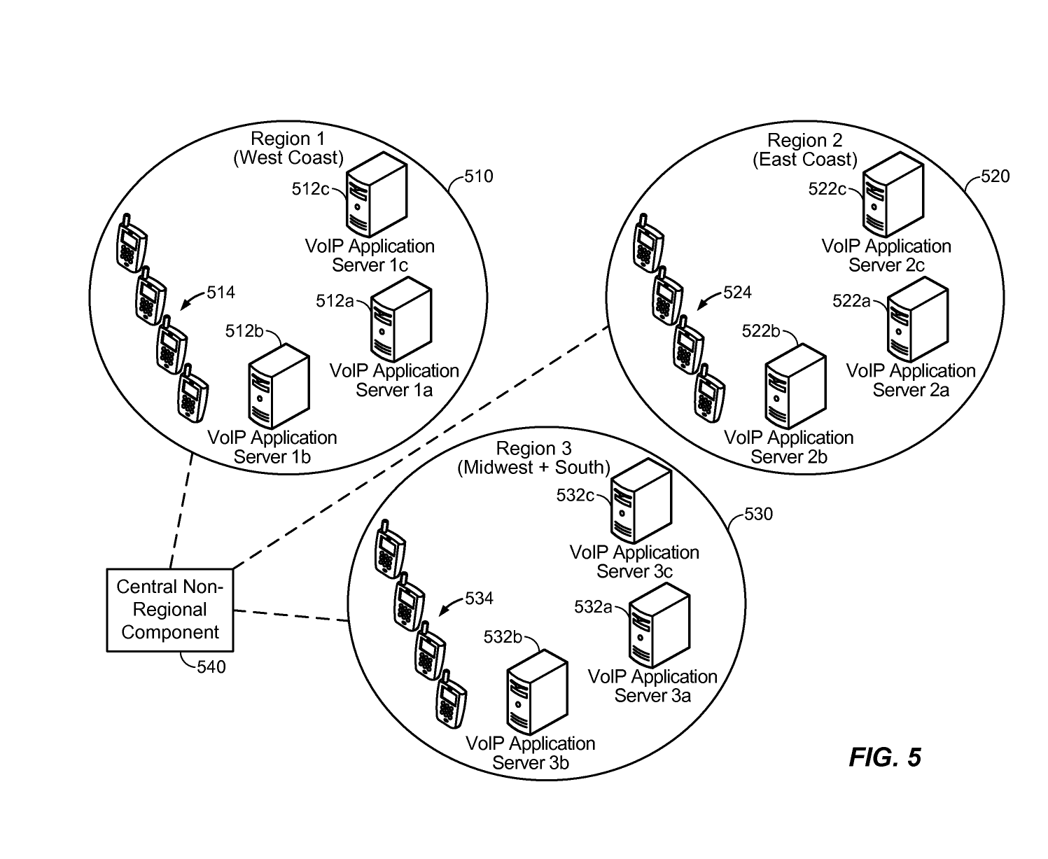

FIG. 5 illustrates an exemplary VoIP deployment. A typical VoIP deployment consists of breaking up a VoIP service area into multiple regions for ease of maintenance, ensuring autonomous processes, such as billing and authorization, and ensuring service continuity in case of a single region failure. In the example of FIG. 5, a service provider may divide a VoIP service area into three different geographic zones or regions, such as a Region 1 510, a Region 2 520, and a Region 3 530. While the regions illustrated in FIG. 5 are geographic regions, the regions may be any type of VoIP service area division, such as regions divided based on resource type and/or availability.

As illustrated in FIG. 5, each region includes several VoIP application servers, similar to application server 170 in FIG. 1, and a number of client devices. The VoIP application servers may communicate with the client devices and each other to provide VoIP services in the respective regions, as is known in the art. Specifically, VoIP application servers 512a-c provide VoIP services for client devices 514, VoIP application servers 522a-c provide VoIP services for client devices 524, and VoIP application servers 532a-c provide VoIP services for client devices 534. A central non-regional component 540, which may be any network component that can detect failures in individual regions, communicates with and coordinates the regions 510-530.

Although FIG. 5 illustrates three VoIP application servers and four client devices in each region, it will be appreciated that there may be any number of VoIP application servers and client devices in each region. Further, although FIG. 5 illustrates regions providing VoIP service, these could be regions providing any packet-based voice communication service.

Occasionally, one or more servers in a region may “go down” or otherwise become non-functional. When that happens, the users (i.e., the users' corresponding client devices) attached to those servers will not be able to receive service. In that case, the users may be failed over to another region, or another server within the same region. Failover, depending upon the service level agreement (SLA), requires service for those affected users to be restored as soon as possible. This typically involves redirecting the affected users in the region that has failed to another region that is still active.

It should be noted that, as used herein, a server failure may be equivalent to a region failure. If a particular server is down in a given region and a client device has no other means to contact another server in that region, then that region is effectively “down” from the perspective of that client device. As such, the techniques described herein apply equally to a failure of an entire region and a failure of a single server within a region. For example, rather than migrating affected client devices to a different region, they can be migrated to a different server within the same region, provided one is available and the other criteria described herein are met.

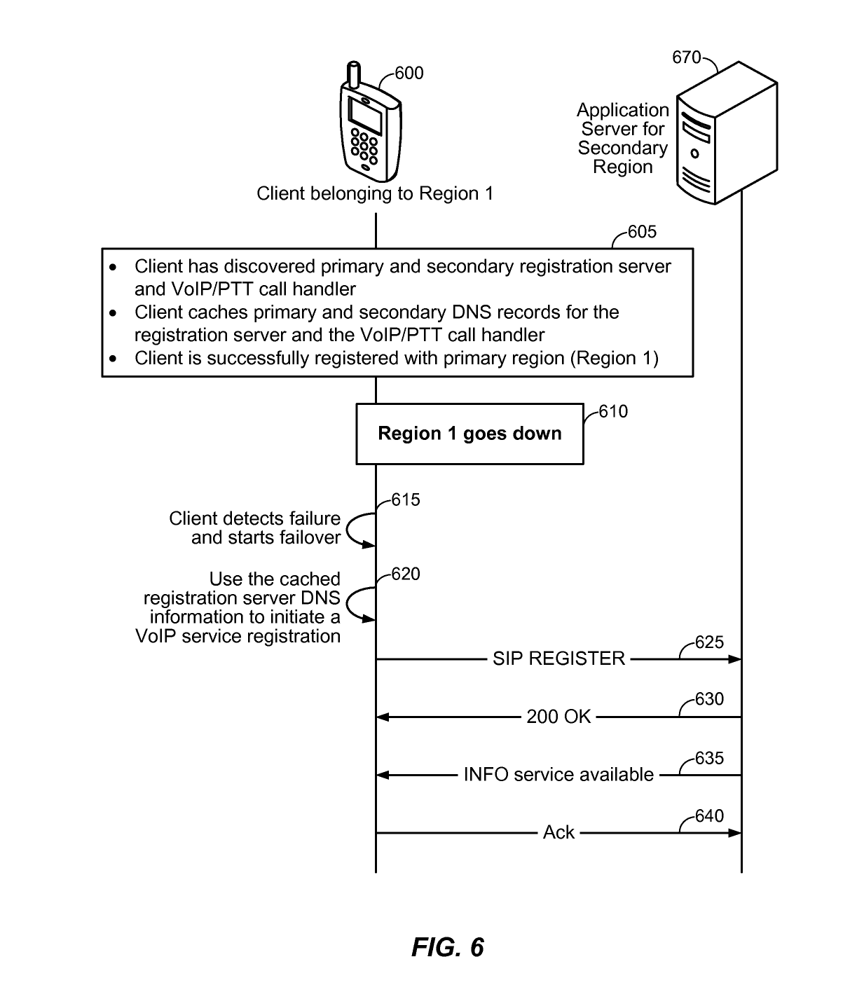

FIG. 6 is a call flow illustrating an exemplary failover to a secondary region/server. At 605, a client device 600, such as one of client devices 514, 524, or 534, has already discovered the registration server and VoIP/PTT call handler for its primary region/server and a secondary region/server, has cached the primary and secondary DNS records for each registration server and VoIP/PTT call handler, and has successfully registered with the primary region/server. As an example, client device 600 may correspond to one of client devices 514 and the primary region/server may correspond to Region 1 510/VoIP Application Server 512a.

At 610, the primary region (e.g., Region 1 510) or primary server (e.g., VoIP application server 512a) goes down. At 615, the client device 600 detects the failure and initiates failover. At 620, the client device 600 uses the cached registration server and VoIP/PTT call handler information to initiate a VoIP service registration with the secondary region/server. As an example, the secondary region/server may be Region 3 530/VoIP application server 512b in FIG. 5. At 625, the client device 600 sends an SIP REGISTER message to a VoIP application server 670. VoIP application server 670 may be an application server in the secondary region, such as one of VoIP application servers 532a-c, or another application server in the first region, such as VoIP application server 512b. At 630, the VoIP application server 670 responds with a 200 OK acknowledgment. At 635, the VoIP application server 670 sends an INFO-service available message to the client device 600. At 640, the client device 600 responds with an acknowledgment (ACK).

In a server-centric failover approach, a central non-regional component, such as the central non-regional component 540 in FIG. 5, can detect that a region has failed and start the failover process of redirecting or moving the clients in the failed region to an active region. In the example of FIG. 6, the client device 600 may detect the failure at 615 by receiving a communication from the central non-regional component indicating the failure or by sending periodic pings to check whether the region is active or not. However, indiscriminate failover may cause network overload and/or capacity overload. Network overload, such as at the RAN and/or backend information technology infrastructure level, may be caused by having to send paging messages to the affected users in the failed region. Capacity overload may result because affected users are now part of the active regions, and the active regions now have to provide service to a greater number of users.

To mitigate such overload, the central non-regional component can prioritize users that need to be failed over to an active region. The prioritization can be based on, for example, the type of user, an activity of the user, or a registration time to live (TTL). As examples of prioritizing based on the type of user, emergency responders or law enforcement officers could be prioritized over other users, premium subscribers could be prioritized over non-premium subscribers, and/or enterprise users could be prioritized over non-enterprise users.

As an example of prioritization based on activity, users that are more active, i.e., that use the communication service provided in the region more frequently, can be prioritized over non-active users. As an example of prioritization based on a registration TTL, those users that have a TTL that will not expire soon can be prioritized, since such users will not trigger re-registration for a longer period of time. Similarly, those users whose TTL will expire soon can be deprioritized since they will try to re-register soon and as such will detect that the region that is serving them has failed.

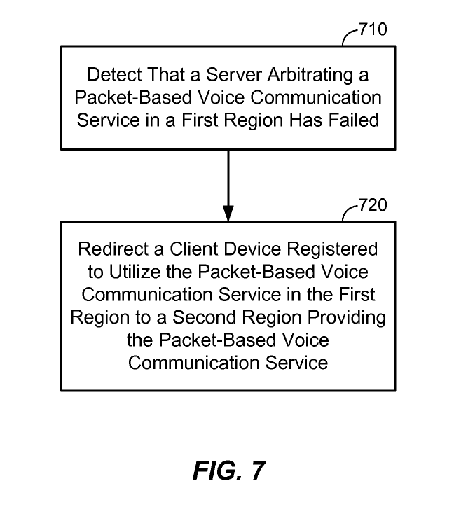

FIG. 7 illustrates an exemplary flow for prioritizing users during a server failure, or, from the perspective of the client devices served by that server, a region failure. The flow illustrated in FIG. 7 can be performed by a central non-regional component, such as central non-regional component 540 in FIG. 5, or a client device, such as any of client devices 514, 524, 534, or 600 in FIGS. 5 and 6.

At 710, the central non-regional component or the client device detects that a server arbitrating a packet-based voice communication service in a first region has failed. The packet-based voice communication service may be a VoIP service and the server may be a VoIP application server. The client device may be registered to utilize the packet-based voice communication service in the first region. The client device may detect the failure by not receiving a response to a ping sent to the server, as is known in the art, or by receiving a notification from the central non-regional component.

At 720, the central non-regional component or the client device redirects the client device to a second server (which may be in the same or a different region) providing the packet-based voice communication service. The redirecting may be based on a priority level of a user of the client device. The priority level of the client device may be based on a classification of the user of the client device. The classification may be one or more of an emergency responder, a premium subscriber, or an enterprise user, for example. In this case, client devices having such a classification may be assigned a higher priority level than client devices that do not have that classification.

Alternatively, or additionally, the priority level of the client device may be based on an activity level of the user of the client device. In that case, client devices having an activity level above an activity threshold may be assigned a higher priority level than client devices having an activity level below the activity threshold.

As yet another alternative, the priority level of the client device may be based on a registration TTL. In that case, client devices having a registration TTL expiring after a threshold period of time may be assigned a higher priority level than client devices having a registration TTL expiring before the threshold period of time.

Where the client device is performing the flow illustrated in FIG. 7, the client device may be provisioned with its priority level when it discovers the registration server and VoIP/PTT call handler for the primary region and the secondary region, for example. Alternatively, the central non-regional component may provision the client device with the priority level upon server failure. Where the central non-regional component is performing the flow illustrated in FIG. 7, it may determine the priority level of the client device in response to detecting the server failure, or it may have previously assigned the priority level.

When the user has multiple client devices registered to utilize the packet-based voice communication service in the first region, the central non-regional component can redirect each of the multiple client devices to the second region based on the priority level of the user.

The various aspects of the disclosure also provide for peer-assisted failover. Initially, a first client device and a second client device are both registered with a first, or primary, region/server. Subsequently, the server, which may be arbitrating a packet-based voice communication service in the first region, fails. At that point, if the first client device attempts to initiate a packet-based voice communication call with the second client device, the first user will detect that the first region has failed, as is known in the art. For example, the first client device may not receive a response within a threshold period of time when attempting to initiate the call.

In response, the first client device will failover to a secondary region/server and attempt to initiate the call with the second client device again. This time, the call should succeed because the second client device still has IP connectivity and the call is hosted by the secondary server, which is also arbitrating the packet-based voice communication service, either in the first region or in the secondary region. During the call, the first client device conveys to the second client device that it was previously registered with the first region but failed over to the secondary region/server. The first client device may communicate this information either in-band or out-of-band.

When the call ends, the second client device detects that the first region/server has failed by, for example, pinging the server in the first region, as is known in the art. When the second client device does not receive a response to the ping, it fails over to the secondary region/server.

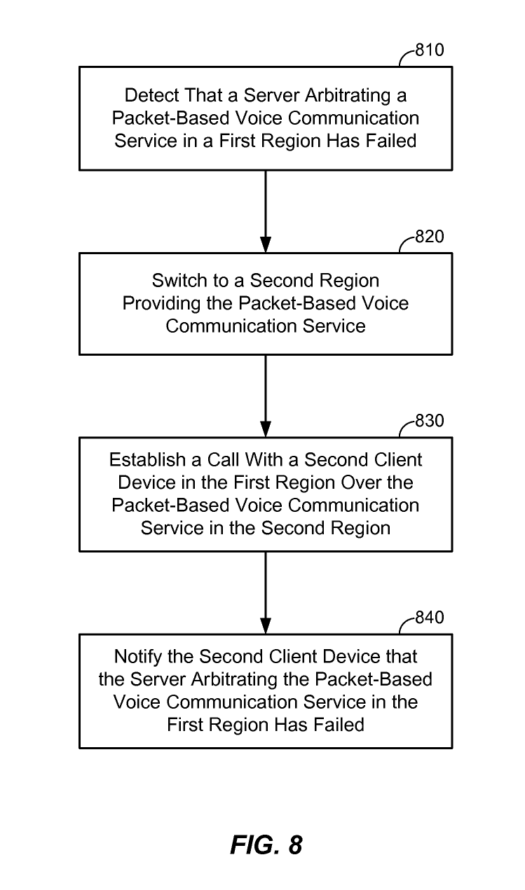

FIG. 8 illustrates an exemplary flow for peer-assisted failover recovery. The flow illustrated in FIG. 8 may be performed by a first client device, such as any of client devices 514, 524, 534, or 600 in FIGS. 5 and 6.

At 810, the first client device detects that a first server arbitrating a packet-based voice communication service in a first region has failed. The packet-based voice communication service may be a VoIP service and the first server may be a VoIP application server, such as any of VoIP application servers 512a-c, 522a-c, and 532a-c in FIG. 5. The first client device may be registered to utilize the packet-based voice communication service in the first region. The first client device may detect that the packet-based voice communication service has failed in response to attempting to initiate a call with a second client device over the packet-based voice communication service in the first region. Alternatively, the first client device may detect the failure by not receiving a response to a ping sent to the first server, as is known in the art.

At 820, the first client device switches to a second region/server in response to detecting that the packet-based voice communication service in the first region has failed. The second region/server may also provide the packet-based voice communication service.

At 830, the first client device establishes a call with a second client device in the first region over the packet-based voice communication service in the second region.

At 840, the first client device notifies the second client device that the first server arbitrating the packet-based voice communication service has failed. The notifying may include transmitting a notification to the second client device in-band or out-of-band. When the call ends, the second client device may detect that the packet-based voice communication service in the first region has failed. In response, the second client device may switch to the second region/server.

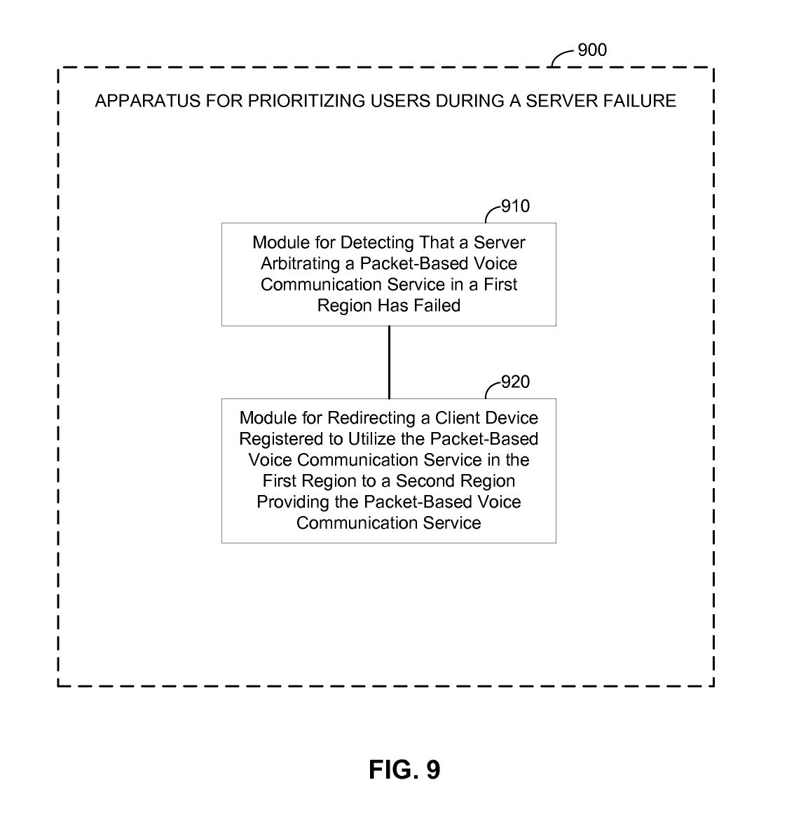

FIG. 9 illustrates an example apparatus 900 for prioritizing users during a server failure, such as a client device or central non-regional component, represented as a series of interrelated functional modules. A module for detecting 910 may correspond at least in some aspects to, for example, a communication device (e.g., a transmitter/transceiver) as discussed herein. A module for redirecting 920 may correspond at least in some aspects to, for example, a communication device (e.g., a receiver/transceiver) as discussed herein.

The functionality of the modules of FIG. 9 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module.

In addition, the components and functions represented by FIG. 9 as well as other components and functions described herein, may be implemented using any suitable means. Such means also may be implemented, at least in part, using corresponding structure as taught herein. For example, the components described above in conjunction with the “module for” components of FIG. 9 also may correspond to similarly designated “means for” functionality. Thus, in some aspects one or more of such means may be implemented using one or more of processor components, integrated circuits, or other suitable structure as taught herein.

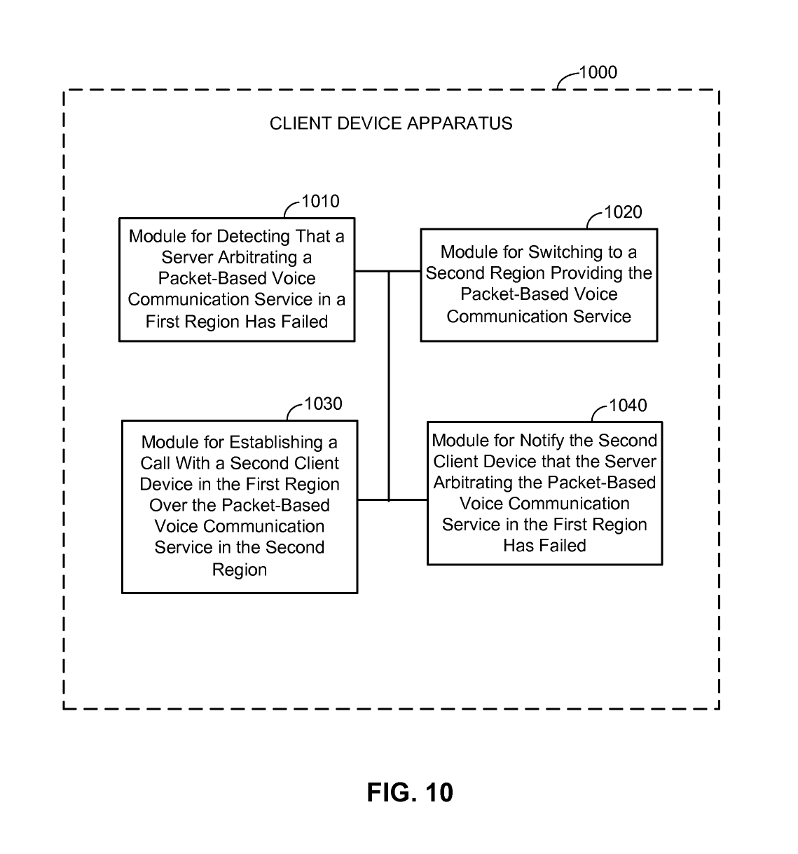

FIG. 10 illustrates an example client device apparatus 1000 for peer-assisted failover recovery represented as a series of interrelated functional modules. A module for detecting 1010 may correspond at least in some aspects to, for example, a communication device (e.g., a transmitter/transceiver) as discussed herein. A module for switching 1020 may correspond at least in some aspects to, for example, a communication device (e.g., a receiver/transceiver) as discussed herein. A module for establishing 1030 may correspond at least in some aspects to, for example, a communication device (e.g., a receiver/transceiver) as discussed herein. A module for notifying 1040 may correspond at least in some aspects to, for example, a communication device (e.g., a receiver/transceiver) as discussed herein.

The functionality of the modules of FIG. 10 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module.

In addition, the components and functions represented by FIG. 10 as well as other components and functions described herein, may be implemented using any suitable means. Such means also may be implemented, at least in part, using corresponding structure as taught herein. For example, the components described above in conjunction with the “module for” components of FIG. 10 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for prioritizing users during a server failure, comprising:
detecting that a server arbitrating a packet-based voice communication service in a first region has failed; and
redirecting a client device registered to utilize the packet-based voice communication service in the first region to a second server providing the packet-based voice communication service, wherein the redirecting is based on a priority level of a user of the client device.

2. The method of claim 1, wherein the priority level of the client device is based on a classification of the user of the client device.

3. The method of claim 1, wherein the priority level of the client device is based on an activity level of the user of the client device.

4. The method of claim 3, wherein client devices having an activity level above an activity threshold are assigned a higher priority level than client devices having an activity level below the activity threshold.

5. The method of claim 1, wherein the priority level of the client device is based on a registration time to live (TTL).

6. The method of claim 5, wherein client devices having a registration TTL expiring after a threshold period of time are assigned a higher priority level than client devices having a registration TTL expiring before the threshold period of time.

7. The method of claim 1, wherein the packet-based voice communication service comprises a voice over Internet protocol (VoIP) service.

8. The method of claim 1, wherein the detecting and the redirecting are performed by a central non-regional component.

9. The method of claim 1, wherein the detecting and the redirecting are performed by the client device.

10. The method of claim 1, wherein the user has multiple client devices registered to utilize the packet-based voice communication service in the first region, and wherein the redirecting comprises redirecting the multiple client devices to the second server.

11. A method for peer-assisted failover recovery, comprising:
detecting, by a first client device, that a server arbitrating a packet-based voice communication service in a first region has failed; and
notifying, by the first client device, a second client device in the first region that the server arbitrating the packet-based voice communication service in the first region has failed.

12. The method of claim 11, wherein the first client device detects that the server arbitrating the packet-based voice communication service has failed in response to attempting to initiate a call with the second client device over the packet-based voice communication service in the first region.

13. The method of claim 11, further comprising:
switching to a second server in response to detecting that the packet-based voice communication service in the first region has failed, wherein the second server provides the packet-based voice communication service.

14. The method of claim 13, further comprising:
establishing a call with the second client device over the packet-based voice communication service provided by the second server.

15. The method of claim 11, wherein the second client device detects that the packet-based voice communication service in the first region has failed, and in response, switches to a second server that provides the packet-based voice communication service.

16. The method of claim 15, wherein the second user device detects that the packet-based voice communication service in the first region has failed in response to an end of the call.

17. The method of claim 13, wherein the second server is in a second region.

18. The method of claim 11, wherein the notifying comprises transmitting a notification to the second client device in-band.

19. The method of claim 11, wherein the notifying comprises transmitting a notification to the second client device out-of-band.

20. The method of claim 11, wherein the packet-based voice communication service comprises voice over Internet protocol (VoIP) service.

21. An apparatus for prioritizing users during a server failure, comprising:
logic configured to detect that a server arbitrating a packet-based voice communication service in a first region has failed; and
logic configured to redirect a client device registered to utilize the packet-based voice communication service in the first region to a second server providing the packet-based voice communication service, wherein the redirecting is based on a priority level of a user of the client device.

22. The apparatus of claim 21, wherein the priority level of the client device is based on a classification of the user of the client device.

23. The apparatus of claim 21, wherein the priority level of the client device is based on an activity level of the user of the client device.

24. The apparatus of claim 21, wherein the priority level of the client device is based on a registration time to live (TTL).

25. The apparatus of claim 21, wherein the user has multiple client devices registered to utilize the packet-based voice communication service in the first region, and wherein the redirecting comprises redirecting the multiple client devices to the second server.

26. An apparatus for peer-assisted failover recovery, comprising:
logic configured to detect, by a first client device, that a server arbitrating a packet-based voice communication service in a first region has failed; and
logic configured to notify, by the first client device, a second client device in the first region that the server arbitrating the packet-based voice communication service in the first region has failed.

27. The apparatus of claim 26, wherein the logic configured to detect that the server arbitrating the packet-based voice communication service has failed comprises logic configured to detect that the server arbitrating the packet-based voice communication service has failed in response to attempting to initiate a call with the second client device over the packet-based voice communication service in the first region.

28. The apparatus of claim 26, further comprising:
logic configured to switch to a second server in response to detecting that the packet-based voice communication service in the first region has failed, wherein the second server provides the packet-based voice communication service.

29. The apparatus of claim 28, further comprising:
logic configured to establish a call with the second client device over the packet-based voice communication service provided by the second server.

30. The apparatus of claim 26, wherein the second client device detects that the packet-based voice communication service in the first region has failed, and in response, switches to a second server that provides the packet-based voice communication service.
